(19) United States
(12) Patent Application Publication
(10) Pub. No.: US 2025/0299570 A1
(43) Pub. Date: Sep. 25, 2025

(54) METHODS AND INTERNET OF THINGS LARGE MODEL SYSTEMS FOR SMART CITY INTEGRATED EMERGENCY MANAGEMENT AND CONTROL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Hang ZHANG, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 19/228,729

(22) Filed: Jun. 4, 2025

(30) Foreign Application Priority Data
May 21, 2025 (CN) 202510657812.1

(51) Int. Cl. G08G 1/087; G01C 21/34; G06Q 10/047; G06Q 10/0631; G06Q 50/26

(52) U.S. Cl. CPC G08G 1/087; G01C 21/3492; G06Q 10/047; G06Q 10/06315; G06Q 50/26

(57) ABSTRACT

The present disclosure provides a method and an Internet of Things large model system for smart city integrated emergency management and control. The method includes: acquiring emergency management and control data; retrieving upload times and data types of the plurality of emergency management and control data and geographic regions to which the plurality of emergency management and control data belongs, and generating data sets to be processed; marking an emergency management and control range and; generating a first traveling route based on an emergency management and control street within the emergency management and control range, and a size of a crowd corresponding to the emergency management and control street, and sending the first traveling route to emergency inspection vehicles; and updating signal light phases in conjunction with travel needs of the emergency inspection vehicles and a traffic flow on the emergency management and control street.

### CROSS-REFERENCE TO RELATED APPLICATIONS

This application claims priority to Chinese Patent Application No. 202510657812.1, filed on May 21, 2025, the entire contents of which are hereby incorporated by reference.

### TECHNICAL FIELD

The present disclosure generally relates to the technical field of smart city emergency management and control, and in particular, to methods and Internet of Things large model systems for smart city integrated emergency management and control.

### BACKGROUND

With the development of smart cities, city emergency management also needs to be gradually improved. However, in the face of a large amount of emergency management and control data from different sources, it is difficult to discover a correlation between different types of emergency management and control data by processing them separately and independently. How to identify emergency management and control data and emergency management and control geographic regions that are correlated is a problem that needs to be solved.

Thereby, methods and Internet of Things large model systems for smart city integrated emergency management and control are provided, which can effectively improve the operational efficiency and the response speed against an emergency event, as well as ensure the effective degree of the emergency management and control.

### SUMMARY

One or more embodiments of the present disclosure provide a method for smart city integrated emergency management and control, being realized based on an Internet of Things large model system. The Internet of Things large model system comprises an emergency supervision user platform, an emergency supervision service platform, an emergency supervision management platform, an emergency supervision sensor network platform, and an emergency supervision object platform. The emergency supervision user platform includes a third-party terminal, the emergency supervision service platform includes a communication terminal, the emergency supervision management platform includes a processor, a master data center, and an emergency sub-platform, the master data center is configured with a memory and a data processing model library, the emergency supervision sensor network platform includes a communication transmission network and a routing device, the emergency supervision object platform is configured with a sensor and a memory, and the emergency supervision object platform is configured to operate based on a plurality of emergency inspection vehicles and communication devices. The method is performed based on the emergency supervision management platform and includes: acquiring a plurality pieces of emergency management and control data through the communication transmission network of the emergency supervision sensor network platform configured in a plurality of geographic regions and storing the plurality pieces of emergency management and control data in the memory in the master data center; retrieving, from the memory in the master data center, upload time and data type of the plurality of emergency management and control data and geographic regions to which the plurality of emergency management and control data belongs, and generating data sets to be processed; marking, in an interactive terminal of a smart city geographic information system (GIS), an emergency management and control range corresponding to a temporary management and control region according to a geographic scope of the geographic regions involved in the data sets to be processed, and displaying the emergency management and control range in an interface of an emergency management and control terminal; generating a first traveling route based on an emergency management and control street within the emergency management and control range, and a size of a crowd corresponding to the emergency management and control street, and sending the first traveling route to the emergency inspection vehicles to control the emergency inspection vehicles to execute the first traveling route and carry out inspection; updating signal light phases in conjunction with travel needs of the emergency inspection vehicles and a traffic flow on the emergency management and control street; and controlling operations of traffic signals within the emergency management and control range based on the updated signal light phases, and controlling signboards of variable lanes within the emergency management and control range to update a traveling direction.

One or more embodiments of the present disclosure provide an Internet of Things large model system for smart city integrated emergency management and control. The system includes an emergency supervision user platform, an emergency supervision service platform, an emergency supervision management platform, an emergency supervision sensor network platform, and an emergency supervision object platform. The emergency supervision user platform includes a third-party terminal, the emergency supervision service platform includes a communication terminal, the emergency supervision management platform includes a processor, a master data center, and an emergency sub-platform, the master data center is configured with a memory and a data processing model library, the emergency supervision sensor network platform includes a communication transmission network and a routing device, the emergency supervision object platform is configured with a sensor and a memory, and the emergency supervision object platform is configured to operate based on emergency inspection vehicles and communication devices. The emergency supervision management platform is configured to perform the method for smart city integrated emergency management and control as above.

One or more embodiments of the present disclosure provide a non-transitory computer-readable storage medium, wherein the storage medium stores computer instructions, and when a computer reads the computer instructions in the storage medium, the computer performs the method for smart city integrated emergency management and control as above.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a platform of an Internet of Things large model system for smart city integrated emergency management and control according to some embodiments of the present disclosure;

FIG. 2 is a flowchart illustrating a method for smart city integrated emergency management and control according to some embodiments of the present disclosure;

FIG. 3 is a flowchart illustrating generating data sets to be processed according to some embodiments of the present disclosure; and

FIG. 4 is a schematic diagram illustrating collecting updated emergency management and control data according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. The present disclosure can be applied to other similar scenarios based on these drawings without creative labor. Unless obviously obtained from the context or the context illustrates otherwise, the same numeral in the drawings refers to the same structure or operation.

It should be understood that as used herein, the terms “system”, “device”, “unit,” and/or “module” as used herein is a method for distinguishing between different components, elements, parts, sections, or assemblies at different levels. However, said words may be replaced by other expressions if other words accomplish the same purpose.

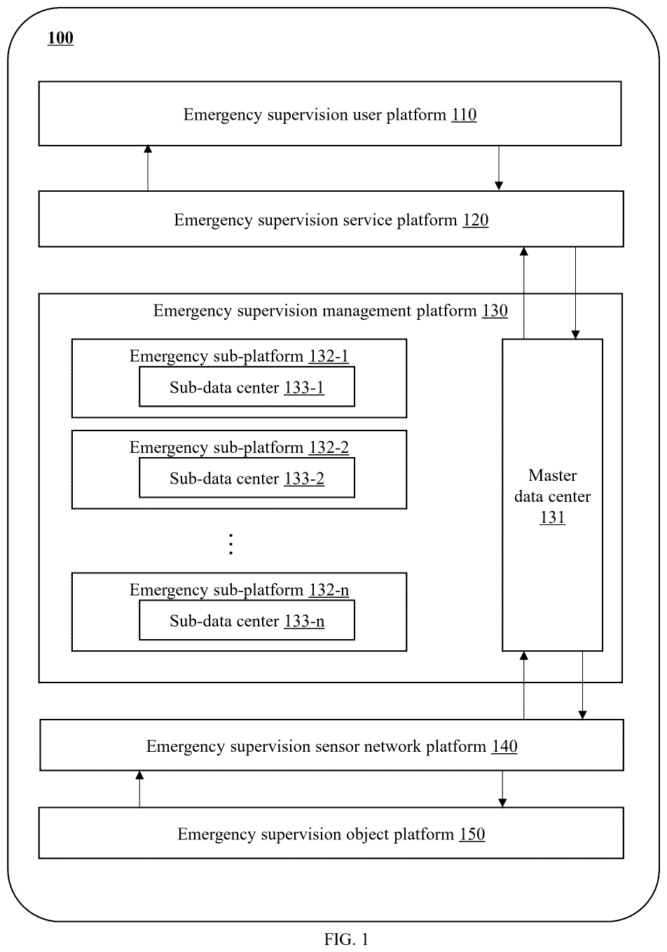

FIG. 1 is a schematic diagram illustrating a platform of an Internet of Things large model system for smart city integrated emergency management and control according to some embodiments of the present disclosure.

In some embodiments, as shown in FIG. 1, an Internet of Things large model system 100 for smart city integrated emergency management and control includes an emergency supervision user platform 110, an emergency supervision service platform 120, an emergency supervision management platform 130, an emergency supervision sensor network platform 140, and an emergency supervision object platform 150.

The emergency supervision user platform refers to a management platform for an integrated coordination of emergency regulation by higher authorities.

In some embodiments, the emergency supervision user platform includes a third-party terminal.

The third-party terminal refers to an external terminal device or an external system software. For example, the third-party terminal may be one of other devices (such as a mobile device, a computer, etc.) with input and/or output functions provided by other organizations or any combination thereof.

The emergency supervision service platform refers to an interactive service platform for receiving and transmitting data.

In some embodiments, the emergency supervision service platform interacts upwardly with the emergency supervision user platform and downwardly with the emergency supervision management platform.

In some embodiments, the emergency supervision service platform includes a communication terminal.

The communication terminal refers to a device or software that realizes real-time information interaction. For example, the communication terminal may be a wireless cell phone, a video monitor, a multimedia computer, or the like.

The emergency supervision management platform refers to a comprehensive platform for processing and managing emergency supervision data.

In some embodiments, the emergency supervision management platform includes a processor, a master data center 131, and a plurality of emergency sub-platforms. The plurality of emergency sub-platforms include corresponding sub-data centers, respectively. As shown in FIG. 1, an emergency sub-platform 1 includes a sub-data center 1, an emergency sub-platform 2 includes a sub-data center 2, . . . , an emergency sub-platform n includes a sub-data center n.

The processor may be configured to process information, such as acquired emergency supervision data. The processor may execute program instructions based on such data, information, and/or processing results to perform one or more of functions described in the present disclosure. For example, the processor may include a central processing unit (CPU), a graphics processor (GPU), a digital signal processor (DSP), etc., or any combination of the above.

The master data center may be configured for an integrated management of the acquired emergency supervision data.

In some embodiments, the master data center is configured with a memory and a data processing model library.

The memory may be configured to store the emergency supervision data and/or instructions. The memory may include one or more storage components, each of which may be a standalone device or may be part of other devices. For example, the memory may include a random access memory (RAM), a read-only memory (ROM), etc., or any combination thereof.

The data processing model library may be configured to store a relevant computational model for integrated processing of data of the emergency supervision management platform, for example, the computational model may include a model for integrated categorization of the emergency supervision data, an integrated analytical model for the emergency supervision data, or the like. The model for categorization may include a binary classification, a decision tree, a random forest, or the like.

The emergency sub-platform refers to a sub-platform that supervises the emergency supervision data.

The sub-data center may be configured to store and process emergency supervision data allocated by the master data center.

In some embodiments, the sub-data center may include a sub-database and a sub-data processing model library. The sub-database is configured to store the emergency supervision data, and the sub-data processing model library is configured to store processing models for the data.

In some embodiments, the master data center 131 may interact with a plurality of sub-data centers.

The emergency supervision sensor network platform is a management platform that transmits emergency supervision-related sensor data or information.

In some embodiments, the emergency supervision sensor network platform interacts upwardly with the plurality of sub-data centers in the emergency supervision management platform, and downwardly with the emergency supervision object platform.

In some embodiments, the emergency supervision sensor network platform includes a communication transmission network and a routing device. The communication transmission network may perform functions of sensor communication of sensor information and control information.

The routing device refers to a hardware device that realizes information sensor communication.

The emergency supervision object platform refers to a platform for collecting the emergency supervision data and executing instructions.

In some embodiments, the emergency supervision object platform is configured with a sensor and a memory. The memory may be configured to store monitored and acquired information and data.

The sensor refers to a device for receiving and transforming various monitoring information. For example, the sensor may include a temperature sensor, a pressure sensor, an ultrasonic sensor, or the like.

In some embodiments, the emergency supervision object platform includes an emergency inspection vehicle and a communication device, and the emergency supervision object platform is configured to operate based on a plurality of emergency inspection vehicles and communication devices.

The emergency inspection vehicle refers to a patrol vehicle that is used for preventing or responding to emergency events. For example, the emergency inspection vehicles may be a driverless vehicle.

The communication device refers to a device for realizing data transmission between the emergency inspection vehicles and the emergency supervision sensor network platform. For example, the communication device may be a vehicle-mounted terminal.

In some embodiments, the emergency inspection vehicle may be equipped with sensors, monitoring devices, memory, or other devices.

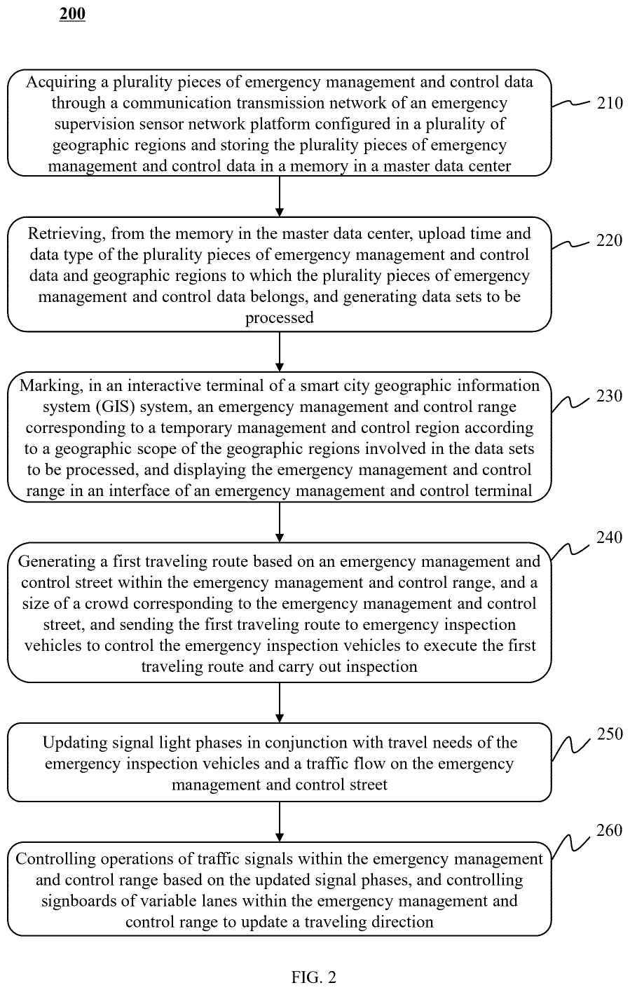

More descriptions of the Internet of Things large model system and the method for smart city integrated emergency management and control can be found in the related descriptions of FIGS. 2-4.

In the embodiments of the present disclosure, the Internet of Things large model system can form a closed loop of information operation, coordination, and regular operation among functional platforms, and efficiently and accurately determine an actual emergency management and control range, thereby improving the handling efficiency when emergency events occur.

FIG. 2 is a flowchart illustrating a method for smart city integrated emergency management and control according to some embodiments of the present disclosure. As shown in FIG. 2, the process 200 includes the following steps. In some embodiments, the process 200 may be performed by an emergency supervision management platform.

Step 210, acquiring a plurality pieces of emergency management and control data through a communication transmission network of an emergency supervision sensor network platform configured in a plurality of geographic regions and storing the plurality pieces of emergency management and control data in a memory in a master data center.

The geographic regions refer to regions obtained by dividing the land region. In some embodiments, the geographic regions may be divided in a plurality of ways. For example, the plurality of geographic regions may be obtained by dividing based on administrative divisions.

In some embodiments, each geographic region is configured with at least one communication transmission network of the emergency supervision sensor network platform.

The emergency management and control data refers to data related to emergency management. For example, the emergency management and control data includes a combustible gas concentration, an environment temperature, an environment humidity, or the like.

The emergency management and control refers to a mechanism proposed to respond to hazardous issues of major accidental disasters (e.g., a gas leak, a fire explosion, a traffic accident, etc.).

In some embodiments, the emergency supervision management platform may interact with the emergency supervision sensor network platform through the communication transmission network to obtain emergency management and control data acquired by sensors configured in different geographic regions in an emergency supervision object platform, and store the emergency management and control data in the memory in the master data center.

Step 220, retrieving, from the memory in the master data center, upload time and data type of the plurality pieces of emergency management and control data and geographic regions to which the plurality of pieces of emergency management and control data belong, and generating data sets to be processed.

The upload time of the emergency management and control data refers to a time when the emergency management and control data is uploaded to the emergency supervision sensor network platform.

The data type of the emergency management and control data includes, but is not limited to, one or more of image data, sound data, text data, or the like.

The geographic regions to which the emergency management and control data belong refer to geographic regions from which the emergency management and control data are acquired.

The data sets to be processed are combinations of the plurality of emergency management and control data. The emergency supervision management platform may generate the data sets to be processed in various ways.

In some embodiments, the emergency supervision management platform may categorize the emergency management and control data based on a preset rule to obtain a plurality of data sets to be processed. The preset rule may be a system default rule or set by a user in advance. For example, the preset rule may include dividing emergency management and control data whose upload time is within 8-11 hours, whose belonging geographic region is region A, and whose data type is text data, into a data set to be processed.

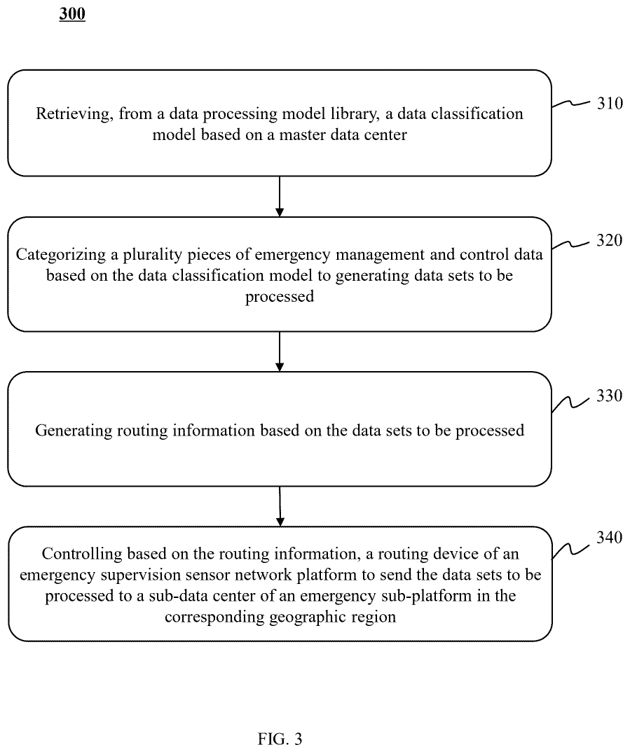

In other embodiments, the emergency supervision management platform may generate the data sets to be processed by a data classification model. See FIG. 3 and related descriptions for more on the data classification model.

Step 230, marking, in an interactive terminal of a smart city geographic information system (GIS), an emergency management and control range corresponding to a temporary management and control region according to a geographic scope of the geographic regions involved in the data sets to be processed, and displaying the emergency management and control range in an interface of an emergency management and control terminal.

The smart city GIS refers to a technical system that collects, stores, manages, calculates, analyzes, displays, and describes relevant geographic distribution data in the whole or part of the Earth's surface space with the support of computer hardware and software systems. The emergency supervision management platform may interact with the smart city GIS through the interactive terminal for data interaction. In some embodiments, the interactive terminal includes a visualization interface.

The emergency management and control range refers to a range of a region that needs to be under emergency management and control.

In some embodiments, the emergency supervision management platform may determine whether the major accidental disasters exist based on the data sets to be processed, and in response to a possibility that the major accidental disasters exist, the emergency supervision management platform determines a geographic region corresponding to the data sets to be processed as the temporary management and control region, and determines a range of a region included in the temporary management and control region as the emergency management and control range. In some embodiments, the emergency supervision management platform may mark a plurality of emergency management and control ranges with different colors, and display the emergency management and control ranges corresponding to the temporary management and control regions in the interface of the emergency management and control terminal.

Step 240, generating a first traveling route based on an emergency management and control street within the emergency management and control range, and a size of a crowd corresponding to the emergency management and control street, and sending the first traveling route to the emergency inspection vehicles to control the emergency inspection vehicles to execute the first traveling route and carry out inspection.

The emergency management and control street refers to a street within the emergency management and control range. The emergency supervision management platform may determine the emergency management and control street through the smart city GIS.

The size of a crowd includes flow of pedestrians and vehicles within the emergency management and control street. In some embodiments, the emergency supervision management platform may determine the size of a crowd based on image data in the data sets to be processed corresponding to the emergency management and control range.

The first traveling route refers to a traveling route determined based on the size of a crowd. In some embodiments, the emergency supervision management platform may screen emergency management and control streets with sizes of a crowd larger than a preset size, and based on distances between the emergency management and control streets and the emergency inspection vehicles, in a one-way order from near to far connecting these emergency management and control streets to obtain the first traveling route.

The emergency inspection vehicles refer to vehicles that carry out inspections during emergency management and control. The emergency inspection vehicles may be driverless vehicles. The inspection includes, but is not limited to, one or more of sounding an alarm to evacuate a crowd via an alarm device, continuing to acquire the emergency management and control data via sensors, etc.

Step 250, updating signal light phases in conjunction with travel needs of the emergency inspection vehicles and a traffic flow on the emergency management and control street.

The travel needs refer to needs of the emergency inspection vehicles during the inspection. For example, the travel needs include emergency management and control streets that the emergency inspection vehicles need to pass through and a traveling direction.

At an intersection, signal lights display different light colors in sequence according to a continuous time sequence, and the light colors of the signal lights are different in different time periods, based on which a plurality of signal light phases can be divided. The signal light phase may be for a travelling route. For example, there are 4 intersections in sequence on a traveling route with signal lights; then the signal light phases may include a time between green lights at an intersection 1 and an intersection 2, a time between green lights at an intersection 2 and an intersection 3, etc., when the emergency inspection vehicle is carrying out the inspection along the traveling route.

The time between green lights refers to a time interval between the moment of the end of a green light of a signal light at the previous intersection on the travel route and the moment of the start of a green light of a signal light at the next intersection.

The emergency supervision management platform may update the signal light phases in various ways. For example, the emergency supervision management platform may estimate a time for the emergency inspection vehicle to arrive at each intersection based on location information of the emergency inspection vehicle, the travel need of the emergency inspection vehicle, and a traffic flow situation of the emergency management and control street, and update the signal light phases based on a time when the emergency inspection vehicle arrives at each intersection so that the signal light is green when the emergency inspection vehicle arrives at each intersection.

In some embodiments, the emergency supervision management platform may generate the updated signal light phases based on the location information of the emergency inspection vehicles, street information of the emergency management and control street, and current signal light phases using a signal light phase model, the signal light phase model being a machine learning model.

The signal light phase model refers to a model used to generate the updated signal light phases. In some embodiments, the signal light phase model is a machine learning model, e.g., the signal light phase model is a Neural Networks (NN) model or other user-defined model, etc.

An input of the signal light phase model includes the location information and traveling route of the emergency inspection vehicle, the street information of the emergency management and control street, and candidate signal light phases, and an output of the signal light phase model includes a count of times that the emergency inspection vehicle corresponding to the candidate signal light phases encountered a red light on its traveling route.

The location information of the emergency inspection vehicle refers to the current location of the emergency inspection vehicle.

The street information refers to information related to the emergency management and control street. For example, the street information includes a street distribution, a signal light distribution, the traffic flow, the current signal light phase, etc. of the emergency management and control street.

In some embodiments, the emergency supervision management platform may obtain, via a positioning system, the location information of the emergency inspection vehicle, the street information of the emergency management and control street, and the current signal light phase. The positioning system includes the Global Positioning System (GPS), the BeiDou Satellite Navigation System, or the like.

In some embodiments, the emergency supervision management platform may randomly generate a plurality of candidate signal light phases.

The emergency supervision management platform may train to obtain the signal light phase model based on a plurality of first training samples with first labels. The emergency supervision management platform may input the first training samples into an initial signal light phase model, construct a loss function based on the output of the initial signal light phase model and the first labels, iteratively update parameters of the initial signal light phase model based on the loss function, and ending the iteration when an end-of-iteration condition is satisfied to obtain the trained signal light phase model. A manner of iteratively updating includes, but is not limited to, a gradient descent manner, and the end-of-iteration condition may be a convergence of the loss function or a number of iterations reaching a threshold.

In some embodiments, the emergency supervision management platform may determine historical location information and a historical traveling route of the emergency inspection vehicle, historical street information of the emergency management and control street, and historical signal light phases during a historical inspection process as the first training sample, and determine a count of times the emergency inspection vehicle actually encounters a red light during the historical inspection process as the first label corresponding to the first training sample.

In some embodiments, the emergency supervision management platform may determine a candidate signal light phase corresponding to the least count of times the emergency inspection vehicle encounters a red light as the updated signal light phase.

The embodiments of the present disclosure determine the count of times the emergency inspection vehicle encounters a red light under the plurality of candidate signal light phases by means of the signal light phase model, and determine the candidate signal light phase corresponding to the least count of times the emergency inspection vehicle encounters a red light as the updated signal light phase, which is able to reduce the waiting time for red lights and effectively improve the inspection efficiency.

Step 260, controlling operations of traffic signals within the emergency management and control range based on the updated signal phases, and controlling signboards of variable lanes within the emergency management and control range to update a traveling direction.

In some embodiments, the emergency supervision management platform may determine the current signal light phases as the updated signal light phases to control the operations of the traffic signals within the emergency management and control range.

In some embodiments, the emergency supervision management platform may set a traveling direction of variable traffic lanes approaching the emergency management and control range to the opposite direction by controlling a signage to reduce the amount of traffic approaching the emergency management and control range.

In the embodiments of the present disclosure, by reasonably determining an emergency management and control range that is in accordance with a reality, the handling efficiency of an emergency incident is improved; by reasonably determining the traveling route of an emergency inspection vehicle, a traffic management and control parameter is favorable to smooth traveling of the emergency inspection vehicle and the inspection to improve the inspection efficiency.

FIG. 3 is a flowchart illustrating generating data sets to be processed according to some embodiments of the present disclosure. As shown in FIG. 3, a process 300 includes the following steps. In some embodiments, the process 300 may be performed by an emergency supervision management platform.

Step 310, retrieving, from a data processing model library, a data classification model based on a master data center.

The data classification model refers to a model used to classify emergency management and control data. For example, the data classification model is a binary classification model, etc.

An input to the data classification model includes the emergency management and control data, and an output of the data classification model includes data sets to be processed.

In some embodiments, a plurality pieces of emergency management and control data inputted into the data classification model are preprocessed and filtered, the preprocessing and filtering of the plurality pieces of emergency management and control data being based on history processing information corresponding to the plurality pieces of emergency management and control data.

The history processing information refers to information related to the classification of the emergency management and control data by the emergency supervision management platform. The history processing information may be obtained based on historical data.

In some embodiments, the emergency supervision management platform determines, based on the history processing information, a frequency at which the emergency management and control data is classified into different data sets to be processed, and marks the plurality pieces of emergency management and control data based on the frequency.

In some embodiments, the preprocessing and filtering may be to classify the emergency management and control data based on the mark, which in turn determines the data set to be processed to which the respective marked emergency management and control data belong. For example, the emergency management and control data is classified into a data set to be processed that has a frequency that is the largest of its marked frequencies and that is greater than a preset frequency threshold. The preset frequency threshold may be set based on historical experience.

The data after being preprocessed and filtered is emergency management and control data that cannot be identified as belonging to a data set to be processed based on the marking process as above. For example, the data after being preprocessed and filtered may be data for which there is no historical classification record in the history processing information or data for which the marked frequency is not greater than the preset frequency threshold.

The embodiments of the present disclosure, by preprocessing and filtering the emergency management and control data, are able to improve the efficiency of the data processing, and reduce the burden of data processing in the master data center.

The emergency supervision management platform may be trained to obtain the data classification model based on a plurality of second training samples with second labels. The training process of the data classification model is the same as that of the signal light phase model, as described more in the related description in step 250.

The second training sample includes sample emergency management and control data, and the second label includes a sample data set to be processed corresponding to the sample emergency management and control data. The second training sample and the second label may be determined based on the history processing information.

Step 320, categorizing the plurality pieces of emergency management and control data based on the data classification model to generate the data sets to be processed.

In some embodiments, the emergency supervision management platform may categorize the plurality pieces of emergency management and control data in the master data center based on the data classification model to generate the data sets to be processed.

In other embodiments, an emergency sub-platform is configured with a sub-data center, and the emergency supervision management platform may categorize a plurality pieces of emergency management and control data in the sub-data center based on a sub-data classification model to generate the data sets to be processed.

More descriptions of the emergency management and control data and the data sets to be processed may be found in FIG. 2 and the related descriptions.

Step 330, generating routing information based on the data sets to be processed.

The routing information refers to information related to data transmission. For example, the routing information includes the data sets to be processed to be sent and the corresponding sender and receiver.

In some embodiments, the emergency supervision management platform may determine the routing information based on actual needs. For example, the emergency supervision management platform determines the master data center as the sender, and determines a sub-data center in a geographic region corresponding to the data set to be processed as the receiver. The geographic region corresponding to the data set to be processed refers to a geographic region to which the emergency management and control data in the data set to be processed belongs.

More descriptions of the geographic region to which the emergency management and control data belong may be found in FIG. 2 and the related descriptions.

Step 340, controlling based on the routing information, a routing device of an emergency supervision sensor network platform to send the data sets to be processed to the sub-data center of the emergency sub-platform in the corresponding geographic region.

In some embodiments, the emergency supervision management platform may, based on the routing information, control a routing device corresponding to the sender to send the data sets to be processed to the receiver.

Some embodiments of the present disclosure, which categorize the emergency management and control data through the data classification model to obtain the data sets to be processed, and send the data sets to be processed based on actual needs, can improve the efficiency of transmission and processing of the emergency management and control data.

In some embodiments, the emergency supervision management platform may also generate an association value of the plurality pieces of emergency management and control data with an emergency event based on a value range of the plurality pieces of emergency management and control data in a preset time period, the geographic regions to which the plurality pieces of emergency management and control data belongs, a type of the emergency event, and a location of the emergency event; determine, based on the association value, the data sets to be processed corresponding to different time periods; delineate the emergency management and control region corresponding to the temporary management and control region based on the data sets to be processed, and the geographic scope of the geographic regions involved in the data sets to be processed; and control the interactive terminal of the smart city GIS to display an electronic map corresponding to the temporary management and control region according to the temporary management and control region.

The value range of the emergency management and control data refers to a range of fluctuation of the emergency management and control data during a preset time period. Different emergency management and control data correspond to different value ranges. For example, if the minimum environment temperature during the preset time period is 10° C., and the maximum environment temperature is 20° C., the environment temperature corresponds to a value range from 10 to 20° C. The preset time period may be a system default or set manually by the user.

The emergency event refers to an event that requires emergency management and control. For example, the emergency event may be a variety of major accidental disasters (e.g., a gas leak, a fire explosion, a traffic accident, etc.). The emergency event includes a major accidental disaster that is occurring or may occur. The location of the emergency event may be determined based on the emergency management and control data.

The association value refers to a degree of correlation between the emergency management and control data and the emergency event. The higher the association value, the higher the correlation between the emergency management and control data and the emergency event. For example, a correlation between a combustible gas concentration and the gas leak is greater than a correlation between an environment humidity and gas leaks. In some embodiments, the association value may be represented by a number between 0 and 1, with the larger the value, the larger the association value.

The emergency supervision management platform may determine the association value in various ways.

In some embodiments, the emergency supervision management platform may obtain, based on historical data, a historical emergency event that has the same type as the current emergency event and occurs at a location in the same geographic region as the current emergency event, and simultaneously obtain a historical value range of emergency management and control data corresponding to the historical emergency event.

The emergency supervision management platform determines the association value based on a degree of overlap between the value range of emergency management and control data corresponding to the current emergency event and the historical value range. The greater the degree of overlap, the greater the association value. When the historical value range includes a value range for the emergency management and control data corresponding to the current emergency event, the association value is the maximum value of 1.

In some embodiments, the emergency supervision management platform may determine a product of the above association value and a type coefficient as the final association value. The type coefficient refers to a coefficient associated with the type of the current emergency event, and the type coefficient may be a system default.

In some embodiments, the emergency supervision management platform may generate the association value of the plurality pieces of emergency management and control data with the emergency event using an emergency association model based on the value range of the plurality pieces of emergency management and control data in the preset time period, the geographic regions to which the plurality pieces of emergency management and control data belongs, the type of emergency event, and the location of the emergency event

The emergency association model refers to a model used to determine the association value. In some embodiments, the emergency association model is a machine learning model, e.g., the emergency association model is a Neural Networks (NN) model or other user-defined model, etc.

An input of the emergency association model includes the value range of the plurality pieces of emergency management and control data in the preset time period, the geographic regions to which the plurality pieces of emergency management and control data belongs, the type of the emergency event, and the location of the emergency event, an output of the emergency association model includes association values of the plurality pieces of emergency management and control data and the emergency events.

In some embodiments, a plurality of emergency events may occur at the same time, at which point the input of the emergency association model may include types and locations of the plurality of emergency events.

The emergency supervision management platform may be trained to obtain the emergency association model based on a plurality of third training samples with third labels. The training process of the emergency association model is the same as that of the signal light phase model, see the related description in step 250 for more.

The third training sample includes, in historical data, a value range the emergency management and control data at the time of a sample emergency event, a geographic region to which the emergency management and control data belongs, a type of the sample emergency event, and a location of the sample emergency event. The third label is an actual association value corresponding to the third training sample. The emergency supervision management platform may determine the third label corresponding to the third training sample based on the third training sample by the manner of determining the association value described above.

In some embodiments, training data of the emergency association model includes a plurality of training samples with labels, the labels being determined based on data sets to be processed corresponding to a plurality pieces of sample emergency management and control data included in the training samples, and the emergency supervision management platform may obtain event processing results corresponding to the training samples (i.e. the third training samples); predict association prediction values (i.e. the third labels) corresponding to the training samples based on the event processing results; in response to the association prediction values being greater than a predetermined sample value, set predetermined label values of the labels corresponding to the training samples, the predetermined label values being greater than a predetermined threshold value; classify the plurality of the training samples into a plurality of training sets based on a plurality of values of the labels corresponding to a plurality of the training samples; and train the emergency association model based on the plurality of training sets.

The event processing results refer to results of processing the sample emergency events corresponding to the third training samples.

The association prediction value refers to an estimate of the association value. In some embodiments, the emergency supervision management platform may obtain a historical value range of historical emergency management and control data for a time period after a historical moment corresponding to the third training sample, and through the abovementioned determination of the association value based on the degree of overlap, determine an association value between the historical value range and the sample emergency event corresponding to the third training sample, and determine the association value as the association prediction value.

In some embodiments, it is possible to determine, based on historical event processing results in a large amount of historical data, which emergency management and control data are effective data for the processing of the emergency event through a priori experience, and store the results to the emergency supervision management platform. For example, if it is found that when the emergency event is a fire, there is a large change in the environment temperature, the traffic flow, and a smoke concentration, these emergency management and control data are determined to be effective data for the processing of the fire. If the emergency management and control data is effective data for the processing of the sample emergency event, the emergency supervision management platform determines, in responds to the association prediction value being greater than the predetermined sample value, the value of the third label as the predetermined label value. The predetermined label value is greater than a preset threshold (e.g., 0.75). If the emergency management and control data is not effective data for the processing of the sample emergency event, the value taken for the third label is unchanged.

The historical emergency management and control data is effective data for the processing of the sample emergency event, which indicates that an actual degree of association between the historical emergency management and control data and the sample emergency events is higher, and when the association prediction value is larger than the predetermined sample value, increasing the value of the third label, the trained emergency association model can accurately predict the association value of subsequent emergency management and control data with higher association value.

In some embodiments, the emergency supervision management platform may divide the third training samples into two training sets. The first training set includes third training samples whose third labels take the values of the predetermined label values, and the rest of the third training samples belong to the second training set. A learning rate corresponding to the second training set is less than a learning rate corresponding to the first training set.

The emergency supervision management platform may be trained to obtain the emergency association model based on the first training set and the second training set. The training process of the emergency association model is the same as that of the signal light phase model, as more described in step 250.

Some embodiments of the present disclosure, considering that the association values may develop and change over time, adjust the third labels based on association values of events within a subsequent time period, and divide third training samples corresponding to the adjusted and unadjusted third labels into different training sets, and train the model based on different learning rates to make the model parameters of the emergency association model more accurate.

Some embodiments of the present disclosure, through a trained emergency association model, can quickly determine the association value between a large amount of emergency management and control data and at least one emergency event to improve data processing efficiency.

In some embodiments, the emergency supervision management platform may divide the emergency management and control data into a plurality of data sets to be processed based on the type of the emergency event, an association value interval (e.g., 0.9-1, 0.8-0.9 . . . corresponding to an association value interval, respectively).

In some embodiments, the emergency supervision management platform may determine the emergency management and control range based on the data sets to be processed by the manner described in step 230.

In some embodiments, the emergency supervision management platform may also determine a management and control time corresponding to each emergency management and control range. For example, the management and control time is positively correlated with a data volume of the emergency management and control data in the data sets to be processed. Furthermore, the management and control time is also correlated to the association value interval corresponding to the data sets to be processed, with the larger the value of the association value interval, the longer the management and control time. The management and control time is also related to a severity of the emergency event; the more severe the emergency event, the longer the management and control time.

More descriptions of how to display the electronic map may be found in step 230 and the related instructions.

In some embodiments of the present disclosure, by determining the association values of different emergency management and control data and emergency events, the more important emergency management and control data can be prioritized to ensure timely data processing.

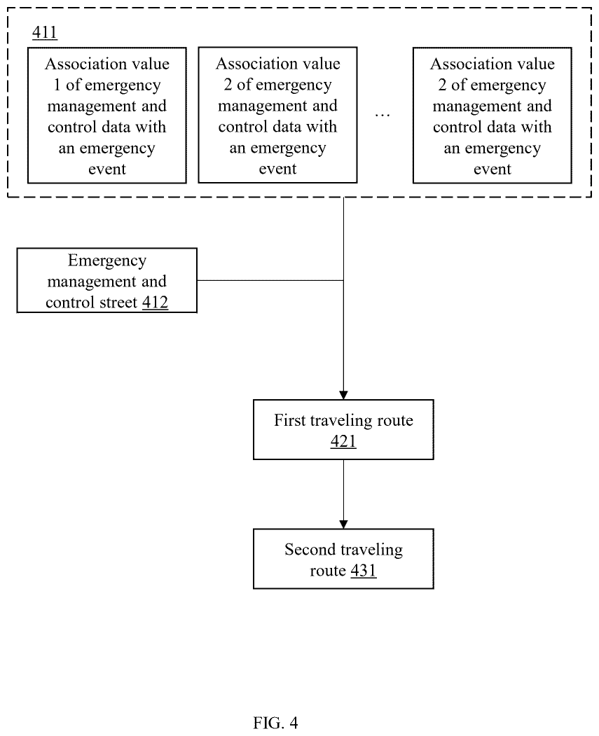

FIG. 4 is a schematic diagram illustrating collecting updated emergency management and control data according to some embodiments of the present disclosure.

In some embodiments, as shown in FIG. 4, an emergency supervision management platform generates a second traveling route 431 by adjusting a first traveling route 421 based on an association value 411 of a plurality pieces of emergency management and control data with an emergency event in conjunction with an emergency management and control street 412; and controls emergency inspection vehicles to execute the second traveling route 431 and conduct an inspection to collect updated emergency management and control data.

In some embodiments, the association value 411 of the plurality pieces of emergency management and control data with the emergency event may includes an association value 1 of the emergency management and control data with the emergency event, an association value 2 of the emergency management and control data with the emergency event, . . . , an association value n of the emergency management and control data with the emergency event.

In some embodiments, more descriptions of the emergency management and control street, the first traveling route, the emergency inspection vehicles, and the association values of the plurality pieces of emergency management and control data with the emergency event may be found in FIG. 2, FIG. 3 and the related descriptions. The second traveling route refers to a traveling route obtained by adjusting the first traveling route based on the association value of the emergency management and control data with the emergency event and the emergency management and control street.

In some embodiments, the second traveling route may be determined by the steps of:

Step 1: determining an emergency management and control range corresponding to a geographic region to which the emergency management and control street belongs, and more description of the emergency management and control range and its determination may be found in FIG. 2 and the related descriptions.

Step 2: obtaining the association value of the plurality pieces of emergency management and control data with the emergency event, more descriptions of the association value may be found in FIG. 3 and the related descriptions.

Step 3: the emergency supervision management platform may take the emergency management and control street corresponding to the emergency management and control data corresponding to the association value as the emergency management and control street corresponding to the association value, and sort the emergency management and control streets corresponding to the association values from largest to smallest. The emergency supervision management platform may determine the association values corresponding to the emergency management and control street for different preset time periods, thereby determining an increased amplitude in the association value for adjacent time periods of the plurality of preset time periods. For example, if an association value of the previous time period is 0.2, and an association value of the current time period is 0.4, the increase amplitude of the association value is 100%. An inspection frequency of the emergency management and control street is positively correlated with the increase amplitude of the corresponding association value in adjacent time periods of the plurality of preset time periods. For example, for every 30% increase in the increase amplitude of the association value within the adjacent time periods, the inspection frequency is increased once.

Step 4: the emergency inspection vehicles generate an adjusted traveling route, i.e., the second traveling route, in accordance with a result of the sorting of the emergency management and control streets.

It is understood that the emergency inspection vehicles traveling to an emergency management and control street with a large association value may complete inspections of other emergency management and control streets passing through with relatively small association values.

In some embodiments, the updated emergency management and control data may be captured in various ways. For example, the emergency inspection vehicles and other processors may collect the updated emergency management and control data during the inspection based on the second traveling route.

In some embodiments, the emergency supervision management platform adjusts the second traveling route to generate a third traveling route based on the updated emergency management and control data in combination with the association value and the emergency management and control street.

The third traveling route refers to a traveling route obtained by adjusting the second traveling route based on the updated emergency management and control data.

In some embodiments, the third traveling route may be determined by the steps of:

Step 1: generating new association values based on the updated emergency management and control data, and more descriptions of generating the association values based on the emergency management and control data may be found in FIG. 3 and the related instructions.

Step 2: sort the emergency management and control streets corresponding to the new association values in descending order of the new association values;

Step 3: the emergency inspection vehicle generates an adjusted traveling route, i.e., the third traveling route, in accordance with a new result of the sequencing of the emergency management and control streets.

In some embodiments of the present disclosure, re-determining the association values of different emergency management and control data based on the updated emergency management and control data in order to update in real time the priority of the emergency management and control street that should be inspected can further improve the inspection of the emergency inspection vehicle in in real time.

In some embodiments of the present disclosure, updating in real time the priority of the emergency management and control streets that should be inspected according to the value of the association value, as well as the inspection frequency, can improve the effectiveness of the inspection of the emergency inspection vehicles; and avoid the occurrence of an untimely inspection.

Some embodiments of the present disclosure further provide a non-transitory computer-readable storage medium, wherein the storage medium stores computer instructions, and when a computer reads the computer instructions in the storage medium, the computer performs the method described in any of the above embodiments.

The basic concepts have been described above, and it is apparent to those skilled in the art that the above-detailed disclosure is intended as an example only and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be considered to be consistent with the teachings of the present disclosure as an example, not as a limitation. Correspondingly, the embodiments of the present disclosure are not limited to the embodiments expressly presented and described herein.

What is claimed is:

1. A method for smart city integrated emergency management and control, being realized based on an Internet of Things large model system, wherein the Internet of Things large model system comprises an emergency supervision user platform, an emergency supervision service platform, an emergency supervision management platform, an emergency supervision sensor network platform, and an emergency supervision object platform,
the emergency supervision user platform includes a third-party terminal, the emergency supervision service platform includes a communication terminal, the emergency supervision management platform includes a processor, a master data center, and an emergency sub-platform, the master data center is configured with a memory and a data processing model library, the emergency supervision sensor network platform includes a communication transmission network and a routing device, the emergency supervision object platform is configured with a sensor and a memory, and the emergency supervision object platform is configured to operate based on a plurality of emergency inspection vehicles and communication devices;
the method is performed based on the emergency supervision management platform and comprises:
acquiring a plurality pieces of emergency management and control data through the communication transmission network of the emergency supervision sensor network platform configured in a plurality of geographic regions and storing the plurality pieces of emergency management and control data in the memory in the master data center;
retrieving, from the memory in the master data center, upload times and data types of the plurality of emergency management and control data and geographic regions to which the plurality of emergency management and control data belongs, and generating data sets to be processed;
marking, in an interactive terminal of a smart city geographic information system (GIS), an emergency management and control range corresponding to a temporary management and control region according to a geographic scope of the geographic regions involved in the data sets to be processed, and displaying the emergency management and control range in an interface of an emergency management and control terminal;
generating a first traveling route based on an emergency management and control street within the emergency management and control range, and a size of a crowd corresponding to the emergency management and control street, and sending the first traveling route to the emergency inspection vehicles to control the emergency inspection vehicles to execute the first traveling route and carry out inspection;
updating signal light phases in conjunction with travel needs of the emergency inspection vehicles and a traffic flow on the emergency management and control street; and
controlling operations of traffic signals within the emergency management and control range based on the updated signal light phases, and controlling signboards of variable lanes within the emergency management and control range to update a traveling direction.

2. The method of claim 1, wherein the method further comprises:
generating the updated signal light phases based on location information of the emergency inspection vehicles, street information of the emergency management and control street, and current signal light phases using a signal light phase model, the signal light phase model being a machine learning model.

3. The method of claim 1, wherein the retrieving, from the memory in the master data center, upload times and data types of the plurality of emergency management and control data and geographic regions to which the plurality of emergency management and control data belongs includes:
retrieving, from the data processing model library, a data classification model based on the master data center;
categorizing the plurality pieces of emergency management and control data based on the data classification model to generate the data sets to be processed;
generating routing information based on the data sets to be processed, and
controlling based on the routing information, the routing device of the emergency supervision sensor network platform to send the data sets to be processed to a sub-data center of the emergency sub-platform in a corresponding geographic region.

4. The method of claim 3, wherein the plurality pieces of emergency management and control data inputted into the data classification model is preprocessed and filtered, the preprocessing and filtering of the plurality pieces of emergency management and control data being based on history processing information corresponding to the plurality pieces of emergency management and control data.

5. The method of claim 3, wherein the method further comprises:
generating an association value of the plurality pieces of emergency management and control data with an emergency event based on a value range of the plurality pieces of emergency management and control data in a preset time period, the geographic regions to which the plurality pieces of emergency management and control data belongs, a type of the emergency event, and a location of the emergency event;
determining, based on the association value, the data sets to be processed corresponding to different time periods;
delineating the emergency management and control region corresponding to the temporary management and control region based on the data sets to be processed, and the geographic scope of the geographic regions involved in the data sets to be processed; and
controlling the interactive terminal of the smart city GIS to display an electronic map corresponding to the temporary management and control region according to the temporary management and control region.

6. The method of claim 5, wherein the generating an association value of the plurality pieces of emergency management and control data with an emergency event based on a value range of the plurality pieces of emergency management and control data in a preset time period, the geographic regions to which the plurality pieces of emergency management and control data belongs, a type of the emergency event, and a location of the emergency event includes:
generating the association value of the plurality pieces of emergency management and control data with the emergency event using an emergency association model based on the value range of the plurality pieces of emergency management and control data in the preset time period, the geographic regions to which the plurality pieces of emergency management and control data belongs, the type of emergency event, and the location of the emergency event, wherein the emergency association model is a machine learning model, and the emergency association model after being trained is stored in a data processing model library.

7. The method of claim 6, wherein training data of the emergency association model comprises a plurality of training samples with labels, the labels being determined based on data sets to be processed corresponding to a plurality pieces of sample emergency management and control data included in the training samples, and
the method further comprises:
obtaining event processing results corresponding to the training samples;
predicting association prediction values corresponding to the training samples based on the event processing results;
in response to the association prediction values being greater than a predetermined sample value, setting predetermined label values of the labels corresponding to the training samples, the predetermined label values being greater than a predetermined threshold value;
classifying the plurality of the training samples into a plurality of training sets based on a plurality of values of the labels corresponding to a plurality of the training samples; and
training the emergency association model based on the plurality of training sets.

8. The method of claim 1, wherein the method further comprises:
generating a second traveling route by adjusting the first traveling route based on the association value of the plurality pieces of emergency management and control data with the emergency event in conjunction with the emergency management and control street;
controlling the emergency inspection vehicles to execute the second traveling route and conduct an inspection to collect updated emergency management and control data.

9. The method of claim 8, wherein the method further comprises:
adjusting the second traveling route to generate a third traveling route based on the updated emergency management and control data in combination with the association value and the emergency management and control street.

10. An Internet of Things large model system for smart city integrated emergency management and control, wherein the system includes an emergency supervision user platform, an emergency supervision service platform, an emergency supervision management platform, an emergency supervision sensor network platform, and an emergency supervision object platform,
the emergency supervision user platform includes a third-party terminal, the emergency supervision service platform includes a communication terminal, the emergency supervision management platform includes a processor, a master data center, and an emergency sub-platform, the master data center is configured with a memory and a data processing model library, the emergency supervision sensor network platform includes a communication transmission network and a routing device, the emergency supervision object platform is configured with a sensor and a memory, and the emergency supervision object platform is configured to operate based on emergency inspection vehicles and communication devices; and
the emergency supervision management platform is configured to perform the method of claim 1.

11. The system of claim 10, wherein the emergency supervision management platform is further configured to:
generate the updated signal light phases based on location information of the emergency inspection vehicles, street information of the emergency management and control street, and current signal light phases using a signal light phase model, the signal light phase model being a machine learning model.

12. The system of claim 10, wherein the emergency supervision management platform is further configured to:
retrieve, from the data processing model library, a data classification model based on a general data center;
categorize the plurality pieces of emergency management and control data based on the data classification model to generate the data sets to be processed;
generate routing information based on the data sets to be processed, and
control based on the routing information, the routing device of the emergency supervision sensor network platform to send the data sets to be processed to a sub-data center of the emergency sub-platform in a corresponding geographical region.

13. The system of claim 12, wherein the plurality pieces of emergency management and control data inputted into the data classification model is preprocessed and filtered, the preprocessing and filtering of the plurality pieces of emergency management and control data being based on history processing information corresponding to the plurality pieces of emergency management and control data.

14. The system of claim 12, wherein the emergency supervision management platform is further configured to:
generate an association value of the plurality pieces of emergency management and control data with an emergency event based on a value range of the plurality pieces of emergency management and control data in a preset time period, the geographic regions to which the plurality pieces of emergency management and control data belongs, a type of the emergency event, and a location of the emergency event;
determine, based on the association value, the data sets to be processed corresponding to different time periods;
delineate the emergency management and control region corresponding to the temporary management and control region based on the data sets to be processed, and the geographic scope of the geographic regions involved in the data sets to be processed; and,
control the interactive terminal of the smart city GIS to display an electronic map corresponding to the temporary management and control region according to the temporary management and control region.

15. The system of claim 13, wherein the emergency supervision management platform is further configured to:
generate the association value of the plurality pieces of emergency management and control data with the emergency event using an emergency association model based on the value range of the plurality pieces of emergency management and control data in the preset time period, the geographic regions to which the plurality pieces of emergency management and control data belongs, the type of emergency event, and the location of the emergency event, wherein the emergency association model is a machine learning model, and the emergency association model after being trained is stored in a data processing model library.

16. The system of claim 15, wherein training data of the emergency association model comprises a plurality of training samples with labels, the labels being determined based on data sets to be processed corresponding to a plurality pieces of sample emergency management and control data included in the training samples, and
the emergency supervision management platform is further configured to:
obtain event processing results corresponding to the training samples;
predict association prediction values corresponding to the training samples based on the event processing results;
in response to the correlation predictions being greater than a predetermined sample value, set predetermined label values of the labels corresponding to the training samples, the predetermined label values being greater than a predetermined threshold value;
classify the plurality of the training samples into a plurality of training sets based on a plurality of values of the labels corresponding to a plurality of the training samples; and
training the emergency association model based on the plurality of training sets.

17. The system of claim 10, wherein the emergency supervision management platform is further configured to:
generate a second traveling route by adjusting the first traveling route based on the association value of the plurality pieces of emergency management and control data with the emergency event in conjunction with the emergency management and control street;
control the emergency inspection vehicles to execute the second traveling route and conduct an inspection to collect updated emergency management and control data.

18. The system of claim 17, wherein the emergency supervision management platform is further configured to:
adjusting the second traveling route to generate a third traveling route based on the updated emergency management and control data in combination with the association value and the emergency management and control street.

19. A non-transitory computer-readable storage medium, wherein the storage medium stores computer instructions, and when a computer reads the computer instructions in the storage medium, the computer performs the method of claim 1.
